(19) United States
(12) Patent Application Publication
(10) Pub. No.: US 2018/0300296 A1
(43) Pub. Date: Oct. 18, 2018

(54) DOCUMENT SIMILARITY ANALYSIS

(71) Applicant: Microstrategy Incorporated, Vienna, VA (US)

(72) Inventors: Siamak Ziraknejad, Reston, VA (US); Ren-Jay Huang, Leesburg, VA (US)

(21) Appl. No.: 15/838,700

(22) Filed: Dec. 12, 2017

Related U.S. Application Data
(60) Provisional application No. 62/486,281, filed on Apr. 17, 2017.

(51) Int. Cl. G06F 17/22; G06F 17/30

(52) U.S. Cl. CPC G06F 17/2211; G06F 17/30011

(57) ABSTRACT

Methods, systems, and apparatus, including computer-readable media, for document similarity analysis. In some implementations, first metadata identifying a first set of metadata objects that define characteristics of a first document is accessed. Second metadata identifying metadata objects that define characteristics of documents in a set of second documents is accessed. Similarity scores are generated indicating similarity of the second documents with respect to the first document. A similarity score for a second document is generated based on an amount of elements in common between (i) the first set of metadata objects and (ii) the set of metadata objects that define characteristics of the second document. A subset of the second documents is selected based on the similarity scores. Data indicating the selected subset of the second documents is provided to a client device.

### CROSS-REFERENCE TO RELATED APPLICATION

This application claims the benefit of U.S. Provisional Application No. 62/486,281, filed Apr. 17, 2017, and titled “Document Similarity Analysis,” which is incorporated by reference.

### BACKGROUND

This specification relates generally to document similarity analysis.

### SUMMARY

In some implementations, a computing system can assess the similarity of documents based on metadata that identifies elements of the documents. For example, documents can include or depend on certain metadata objects from a central, governed metadata repository. Individual metadata objects can be referenced or reused to define many different documents across an enterprise. The computing system can determine a similarity score indicating how similar two documents are, for example, according to the number of metadata objects that are shared between the two documents. Documents that have a high number of metadata objects in common can be determined to be highly similar, while documents that have fewer metadata objects in common can be determined to be less similar. The similarity analysis can also take into account the types of metadata objects that documents have in common, allowing the system to weight the importance of different categories of metadata objects differently. Using this similarity analysis technique, the computing system can identify documents that are most similar to a document of interest to a user, and may provide or recommend the identified documents to the user.

The similarity analysis can provide high accuracy and robustness in making similarity determinations. Assessing similarity of the metadata defining the structure of documents can provide improved results compared to systems that do not assess document structure. For example, some systems that look for matching document content to determine similarity may not recognize the similarity of documents if abbreviations, misspellings, or different words are used, even if the documents refer to the same topics or concepts. Similarly, systems that assess document content may not correctly determine which fields or portions of documents should be compared. For example, it may not be clear whether a term in a document represents a person's first name, a person's last name, general text, or some other type of data, and thus what fields of another document would be appropriate to match. As discussed further below, similarity analysis based on metadata for a document's structure is generally not subject to these issues.

The computing system can use a set of object definitions applicable to many documents, so documents being compared are defined according to metadata objects from the same central, governed metadata repository. Comparing the identity of metadata objects of a document, e.g., the metadata objects that are included a document or were used to create the document, allows similarity to be detected even in the absence of actual matches between the displayable content of the documents. For example, two documents may refer to the same data set and include different types of charts to illustrate the data set. Even if the documents include completely different text descriptions and visually appear very different, a degree of similarity can be determined from the reference to the same data set and the fact that both have a chart that references the data set. Thus, while only a limited amount of content that would be displayed to a user matches between documents, an appropriate level of similarity can still be detected.

In some instances, using the metadata defining a document's structure and content can reduce the risk of attributing excessive similarity due to matches of content that is common across a set of documents. In situations where many documents have similar content, the similarity analysis techniques discussed in this document can better identify documents that are related to each other. Many reports of a similar type may have a high degree of matching keywords or other text content, for example. However, fewer documents may refer to the same metadata objects, e.g., by referencing the same data sets and filter parameters. The documents that do use the same metadata objects can be recognized as more related to a document of interest, even though other documents may have a greater amount of matching text or other content.

The similarity analysis techniques discussed herein also provide a computationally efficient technique for assessing similarity of documents. In some implementations, document similarity is determined from a number of metadata objects in common between documents. A computing system can compare the identifiers for the metadata objects of different documents with low computational complexity, which can allow for fast and efficient generation of document similarity scores.

In a general aspect, a method includes: accessing, by the one or more computers, first metadata identifying a first set of metadata objects that define characteristics of a first document; accessing, by the one or more computers, second metadata identifying metadata objects that define characteristics of documents in a set of second documents; generating, by the one or more computers, similarity scores indicating similarity of the second documents with respect to the first document, where the similarity score for a second document is generated based on an amount of elements in common between (i) the first set of metadata objects and (ii) the set of metadata objects that define characteristics of the second document; selecting, by the one or more computers, a subset of the second documents based on the similarity scores; and providing, by the one or more computers, data indicating the selected subset of the second documents to a client device.

Other embodiments of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

Implementations may include one or more of the following features. For example, in some implementations: accessing the first metadata includes determining a first set of identifiers of metadata objects that are referenced by or were used to generate the first document; accessing the second metadata includes determining, for a particular document in the set of second documents, a second set of identifiers of metadata objects that are referenced by or were used to generate content of the particular document; and generating the similarity scores includes determining a similarity score for the particular document based on identifying matching identifiers in first set of identifiers and the second set of identifiers.

In some implementations, generating the similarity scores includes determining a similarity score for a particular document of the second documents by: determining a similarity measure for each of multiple different categories of metadata objects; determining a weighting for each of the multiple different categories; and determining the similarity score based on weighting the similarity measures for the multiple different categories by their respective weightings.

In some implementations, accessing the metadata indicating the elements of the first document includes: determining first metadata objects are referenced by the first document; determining that the first metadata objects depend on additional metadata objects that are not referenced by the first document; and determining, as the first set of metadata objects, a combined set of metadata objects that includes the first metadata objects and the additional metadata objects.

In some implementations, generating the similarity scores includes determining a similarity score for a particular document of the second documents based on determining that the first document and the particular document each reference metadata objects of a same object type.

In some implementations, identifying the first document, comprising at least one of: receiving data indicating user input to select the first document; receiving data indicating that a user accessed the first document; receiving data indication an end of the first document is reached; or determining that the first document is in a document collection of the first user.

In some implementations, generating the similarity scores includes determining a similarity score for a particular document of the second documents based on data indicating a frequency of access of the second document.

In some implementations, providing the data indicating the selected subset of the second documents to a client device is performed in response to receiving data indicating that a user of the client device selected the first document.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram that illustrates an example of a system for document similarity analysis.

FIG. 2 is a diagram that illustrates an example of a document.

FIG. 3 is a diagram that illustrates an example of a user interface showing results of document similarity analysis.

FIG. 4 is a flow diagram of an example process for document similarity analysis.

FIG. 5 shows an example of a computing device and a mobile computing device.

Like reference numbers and designations in the various drawings indicate like elements.

### DETAILED DESCRIPTION

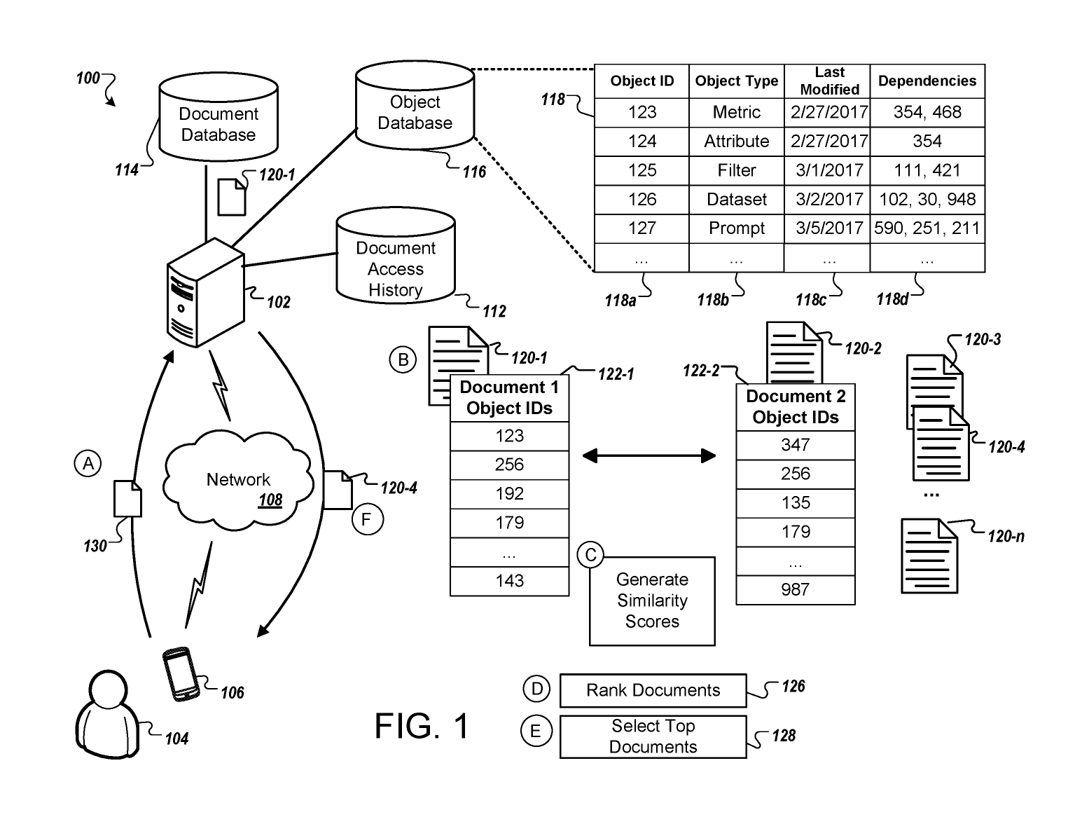

FIG. 1 is a block diagram that illustrates an example of a system 100 for document similarity analysis. The system 100 includes a server 102, a document access history 112, a document database 114, an object database 116, a client device 106, and a network 108. FIG. 1 illustrates various operations in stages (A) to (F) which can be performed in the sequence indicated or in another sequence.

The system 100 can be used to evaluate the similarities between documents. This information can used to cluster related documents, or to provide a user an indication of the documents that are most similar to a document of interest to the user. To determine the level of similarity between two documents, a computing system, such as the server 102, can compare metadata that defines the structure, content, and relationships of elements of the documents. This process can involve identifying metadata objects that are included in or were used create the documents. Commonalities identified among the metadata objects of different documents indicate similarity of the documents. With this technique, the system assesses the fundamental building blocks that make up a document and define its content. As a few examples, metadata object types may represents datasets, attributes, metrics, filters, prompt, prompts, and graphs or other visualizations. In some implementations, these metadata objects are items that are distinct from the objects or components actually form the displayable contents of a document. In other applications, the techniques for analysis of metadata objects as discussed herein may be performed for any or all objects or components of a document, including visually renderable elements or other components, and not just for metadata objects.

The server 102 can include one or more computers, and may include computers distributed across multiple geographic locations. The server 102 communicates with one or more data storage devices that provide access to the document access history 112, document database 114, and object database 116.

The client device 106 can be, for example, a desktop computer, a laptop computer, a tablet computer, a wearable computer, a cellular phone, a smart phone, a music player, an e-book reader, a navigation system, or any other appropriate computing device. The network 108 can be wired or wireless or a combination of both, and can include the Internet.

The server 102 can be part of an enterprise platform that allows users to create, edit, share, and manage documents. To facilitate the creation of documents, various metadata objects can be defined and made available to users. Each metadata object can have a unique identifier and a definition specified in the object database 116. Information about the metadata objects may be made available to many users, for example, to users in a company or other organization.

When a user creates a document, the user can select from the list of available metadata objects to add or refine content in the document. The user may optionally define a new metadata object, which may be entered in the object database 116. Customized metadata object may be made available to other users or not. A user can define document content in terms of the metadata objects in the object database 116. For example, a user may create a document that includes a chart showing a company's performance over time. A user interface of a document editor may provide the user a list of available “chart” type metadata objects, e.g., respectively representing a bar chart, a pie chart, a line graph, etc., that are populated from the data in the object database 116. After selecting an appropriate chart object, the user may select which data should be displayed in the chart, by selecting from among various dataset objects indicated by the object database 116. The dataset objects may represent data for different organizations, data different departments of an organization, or other collections of data. To tailor the chart in the document further, the user may select a data filter from among filter objects indicated by the object database 116, e.g., a filter by time range, filter by location, filter by organization or department, and so on. In this manner, the options populated on the screen of the document editor, and the items selected by the user to define the content to display in the document, correspond to specific metadata objects defined in the object database 116.

While documents are created or edited, the server 102 or another computing system tracks which metadata objects are selected and used to define the documents. The resulting document, and metadata identifying the metadata objects used to create the document, are stored in the document database 114. The metadata for a document may be included in a document or in a separate file or database. For example, a document that includes a chart may reference a particular chart object and include parameter indicating location and formatting for the chart to be displayed. Interactive documents may reference metadata objects representing interactive elements, such as filter controls, that allow a recipient of a document to access to adjust or select from different filter objects when viewing the document. Even for a document that is created to be static or non-interactive, metadata indicating the metadata objects that a user selected when creating or editing document content can be stored in association with the resulting document. For example, even if a document is not interactive and shows a fixed chart, the metadata for the document can indicate the chart object, dataset object, and filter object that were used by the creator of the document to arrive at the final chart shown in the document.

In the example of FIG. 1, the server 102 determines that a particular document is of interest to user 104 of a client device 106. The server 102 then compares metadata indicating the metadata objects that define the particular document with metadata indicating the metadata objects that define other documents in a document collection. Based on metadata objects in common among the particular document and other documents, the server 102 assigns similarity scores to various documents and provides the client device 106 a list of documents identified as most similar to the particular document.

During stage (A), the server 102 obtains data 130 that identifies a document 120-1. For example, the client device 106 may send data that includes a document identifier indicating a document of interest to a user. The data can indicate a particular document, for example, a document the user 104 selects on a user interface, a document the client device 106 requests to open or download, a document displayed at the client device 106, a document in a library or a document collection of the user 104, etc. The document identifier may be a numerical identifier, a name of a document, a file name, a reference to the document such as a URL, or other data that identifies a document. In some instances, the data may include the document itself, for example, if a client device 106 uploads or saves the document to server-based storage.

In the illustrated example, user 104 selects a document from among a set of documents in the user's document library. In response, the client device 106 sends data 130 that includes a document identifier for the selected document, referred to later as document 120-1, to the server 102 over the network 108. As noted above, other methods can be used to obtain data indicating a document of interest to a user. For example, the server 102 may access a list of documents in a user's library or a list of documents that the user is currently viewing or has recently viewed (e.g., within a threshold amount of time), and the server 102 may identify similar documents for one or more documents in the list.

During stage (B), the server 102 retrieves information associated with the document 120-1 from one or more databases. For example, the server 102 uses the document identifier for the document 120-1 to access the document and/or its associated metadata in the document database 114. From this information, the server 102 determines an object list 122-1 that specifies the metadata objects that define the content of the document 120-1. For example, the object list 122-1 can be a list of object identifiers for the metadata objects used to define the document 120-1.

The document database 114 can include a repository of metadata for documents in a document collection, for example, for documents of many different users in an enterprise. For example, the document database 114 includes a list of metadata objects associated with each document. The document database 114 includes, for each document in the document collection, metadata identifying the metadata objects that define the document. For example, the identified metadata objects may be metadata object that are included in or referenced by the document. The identified metadata objects may include metadata objects used in the process of creating the document, e.g., a log or history of user selections of metadata objects to define characteristics of or content of the document. The document database 114 may include stored documents, or the documents may be distributed among other devices. The metadata for a document may be stored in any of various formats, for example, as metadata within the document, as a file separate from the document, in an index of document information, or in database records.

To determine the object list 122-1 for a specific document 120-1, the server 102 may look up information in the document database 114 using the document identifier as an index value. The document database 114 may store the metadata for the particular document 120-1 in association with a document identifier that distinguishes the document 120-1 from the other documents in the document collection, allowing the information for the document 120-1 to be retrieved based on the document identifier.

The server 102 may look up additional information about the metadata objects that define the document 120-1 in the object database 116. As noted above, the object database 116 includes information regarding each of the metadata objects that represent component documents in the document collection being assessed for similarity with the document 120-1. For example, the object database 116 can indicate, for each metadata object, an object identifier 118a, an object type 118b, a last modified date 118c, and any dependencies 118d of the metadata object. The object database 116 can also indicate other parameters that define each metadata object, e.g., text content or numerical content of an attribute, a function defined to generate a metric, a specific collection of records that represent a dataset, and so on.

The table 118 shows information about certain example metadata objects. The metadata object that has an object identifier of “123” is specified to be of the “Metric” type and was specified to be last modified on Feb. 27, 2017. The metadata object with identifier “123” is also indicated to be dependent on two other metadata objects having object identifiers “354” and “468.” This dependency may indicate that the metadata object is an instance of or a narrower variation of another metadata object, and so may derive some of its definition from the other object. Similarly, the dependency could indicate a related or complementary metadata object. For example, if the metric involves a function to generate a certain statistical measure, the metadata objects depended on could represent other metadata objects of the metric type that define data conversions to prepare data for the function represented by object with identifier “123.” The dependencies may be indicated as a list of objects depended on, or the dependency information may be more detailed. For example, dependencies of different types may be distinguished from each other and indicated in the object database 116.

The server 102 may use the information in the object database 116 to enhance the object list 122-1. For example, the server 102 can determine the object type for each of the metadata objects identified for the document 120-1, if not indicated already in the document database. As discussed below, objects of different types may be evaluated differently in the similarity analysis. The server 102 may determine groups of the object identifiers in the object list 122-1 representing different categories of objects to facilitate this processing. In addition, the dependencies of the metadata objects in the object list 122-1 can be identified. The metadata objects indicated as dependencies can be added to the object list 122-1, since the document 120-1 relies on those metadata objects also. Alternatively, a separate object list may be generated to list the objects depended on, since these objects may not represent the content of the document 120-1 as closely as metadata objects that are directly referenced in the document 120-1 or that were directly selected by a user to create the document 120-1. Metadata objects identified as dependencies can be recursively checked to include metadata objects that they depend on included in an appropriate list for the document 120-1.

During stage (C), the server 102 determines similarity scores indicating the level of similarity between documents in the document collection and the document 120-1. This process can involve comparing the set of components of the document 120-1, e.g., the metadata objects indicated in the object list 122, with the set of components in the documents in the document collection. In general, the more metadata objects that two documents have in common, the greater the similarity between the two documents.

The document collection represented by the document database 114 is illustrated as documents 120-1 to 120-n. The server 102 can access metadata for each of the documents in the document collection, and determine an object list for each of those documents in the same manner discussed above for determining the object list 122-1 for document 120-1. The server 120 may then compare the contents of the object list 122-1 with the contents of an object list for another document to determine a similarity score indicating how similar the other document is to the document 120-1.

As an example, to determine a similarity score indicating the similarity between document 120-1 and document 120-2, the server 102 compares the contents of the object list 122-1 and object list 122-2. The server 102 determines that both object lists include object identifier “256” and object identifier “179,” which indicates that both documents include or were generated using the metadata objects represented by these identifiers. In some implementations, the number of matches identified between the respective metadata objects for the two documents may be used as a similarity score. Other more fine-grained approaches may used, as discussed below.

The object types of objects shared between documents can be taken into account to weight the relative importance of different categories of object types. Simply counting of the number of objects in common between two documents would weight objects of all types equally. Some types of object may be more indicative of document content than others, however. To account for this, matches for different categories of objects may be weighted differently. In some implementations, the weightings can prioritize the object types, in order from most important to least important, for datasets, attributes, metrics, filters, and prompts. The number of matches of objects of a certain object type can be multiplied by its corresponding weight. As an example, the number of dataset objects in common can be multiplied by a weight of 1.5, the number of attribute objects in common can be multiplied by a weight of 1.3, the number of metric objects in common can be multiplied by a weight of 1.1, the number of filter objects can be multiplied by a weight of 1.0, and the number of prompt objects in common can be multiplied by a weight of 0.8. In this manner, a score for each object type can be determined, as the number of object matches for each object type, multiplied by the corresponding weight for the object type. The various scores for different object types can be summed to represent the overall similarity of the two documents.

Dependency information can be taken into account to determine similarity scores also. In some implementations, metadata objects identified through dependency (e.g., metadata objects that are not directly used to define a document, but which are relied on by metadata objects that do define the document), can optionally be treated in the same manner as metadata objects that define the document. That is, identifiers for metadata objects indirectly relied on by a document can be included in the object lists 122-1 to 122-n. Matches in object identifiers among two object lists can be used as indications of document similarity, even if the identifiers were included due to a dependency relationship. In some implementations, a separate dependency list is determined for a document to include object identifiers representing objects relied on through dependency. Matches between object identifiers in a dependency list may be weighted less than matches for objects in the main object lists 122-1 to 122-n. For example, when two documents both include the same object, the match may be fully weighted, e.g., with a match of 1. When two documents are both associated with the same object, but one of the documents is only associated with the object through dependency, the match may be discounted or given a reduced weighting, e.g., 0.5. If both of the documents are associated with an object through dependency only, then further reduced weighting may be given to the match, e.g., 0.25.

In some implementations, the calculation of a similarity score may be weighted according to data indicating a history of access of a document. For example, similarity scores may be weighted according to a frequency or probability of access to a document. In many instances, a document collection may include many versions of a document with only minor changes, e.g., as different users create local, personal copies and make annotations. In these situations, a search for similar documents may show many copies of nearly identical documents to be the most similar, and it may be difficult to determine which copy is the most authoritative or correct version. Similarly, many near-identical copies would crowd out other useful results. In these scenarios, the similarity of the primary version can be boosted or the similarity of the copies penalized using document access frequency. A weighting factor may be may be applied based on how frequently the document is accessed. The server 102 can access document access history 112 to determine how frequently a document is accessed, and weight the similarity score accordingly. For example, a probability of access of a document may be determined, e.g., as a number of accesses of a particular document, divided by a total number of document accesses to all documents in a collection. This access probability measure may be used to weight the similarity measure determined based on objects in common as noted above. For example, when calculating a similarity score to indicate the similarity of document 120-2 to document 120-1, an access probability for document 120-2 can be multiplied by a count of matching object between the object lists 122-1 and 122-2.

In some implementations, the server 102 generates a document similarity measure as expressed mathematically in equation (1) below. In the equation, j represents an index for a “source” document, such as one that is interacted with by a user or identified by the user in some form, e.g., by a user selection, by a user viewing the document, and so on. For example, the j^{th} document may be included in a small document set specific to the user, such as a personal document collection or library that the user has assembled. Document i represents a “target” document to be compared with the document represented by index value j. The value i can represent a document from a document collection, database, or gallery, e.g., the i^{th} document of a full document list stored in the database. This document collection or database can be a large collection having documents from multiple users, such as a document set for an entire department or enterprise. Equation (1) determines the weighted average of commonality between a first document j (e.g., document 120-1) with respect to a second document i (e.g., document 120-2), and weights this commonality by a measure of document viewing frequency for document i:

$${s}_{ij} = {p}_{i} \cdot {\sum }_{k = 0}^{m} ( \frac{{X}_{i , k} ⋀ {X}_{j , k}}{m} \cdot {w}_{k} ) , {s}_{ij} ⋐ [ 0 , 1 ] \qquad ( 1 )$$

where
sᵢⱼ is the similarity score of document i vs. document j,
X_{i,k}={x_{i,1}, x_{i,2}, . . . , x_{i,k}, . . . , x_{i,m}}, is the feature vector of document i,
X_{j,k}={x_{j,1}, x_{j,2}, . . . , x_{j,k}, . . . , x_{j,m}}, is the feature vector of document j,
m is the total number of unique objects (i.e. the length of the pattern),
wₖ is the predefined weight of the attribute k, of which type the attribute belongs to,
pᵢ is a probability of the document i being viewed, where pᵢ may be calculated as

$${p}_{i} = \frac{{f}_{i}}{{\sum }_{y = 1}^{n} {f}_{y}} ,$$

where n is the total number of “unique” documents in the document collection or gallery of documents to be compared with document j, and
∧ is a bitwise AND operator.

In equation (1), the server 102 compares the objects associated with document i to the objects associated with document j. The value m represents the total number of unique objects in the object database 116. The feature vectors represent vectors having m values, each feature representing whether a document includes, or is otherwise associated with, a different one of the m objects in the database. Within each of the feature vectors X_{i,k} and X_{j,k}, the feature xₖ of either document i or j is a binary value, {0 or 1}, representing whether or not the document contains the kth object. The variable k is equivalent to a numerical index corresponding to a specific object identifier. The result of the AND operator will be one only if both documents are associated with the same object, which would be the case when an object matches or is in common between the two documents.

The weight wₖ is a weight that can be assigned based on the object type of the object at position kin the list of m objects. As noted above, matches for different object types can have different weightings, and the weight wₖ expresses this feature. If the object corresponding to the value of k is a dataset, the weighting value for a dataset object type is used. Similarly, if the object is a filter, the weighting value for the filter object type is used. In this way, a match for any of the objects in the object database 116 is weighted by the weighting that is appropriate for its object type.

As a simple example of calculating pᵢ, a document collection may include three unique documents, A, B, and C. As a result, the value of n is 3. A document list of various documents saved in one or more locations may indicate six document instances, A, B, A, A, C, and B. From these different copies, the frequency for document A may be p_{A}=3/(3+2+1)=½; the frequency for document B may be p_{B}=2/(3+2+1)=⅓; and the frequency for document C may be p_{C}=1/(3+2+1)=⅙. As an alternative, instead of saved copies of the documents, the probability may be generated from access records that indicate six different instances of users accessing the documents, e.g., document views A, B, A, A, C, and B.

The viewing frequency value pᵢ is a statistic that can be calculated by taking into account all documents from the document collection or database. For example, pᵢ can indicate how many times the i^{th} document is found in the database, or how frequently the i^{th} document has been used. A measure of how often a document has been used may count a specific type of action, e.g., a number of times the document has been viewed, or may count multiple different types of accesses, e.g., views, shares, edits, annotations, etc.

The server 102 may carry out the principles expressed in equation 1 in various ways. For example, the server 102 may calculate and store feature vector X for each document in the document collection, to indicate which metadata objects are present in each document. With these feature vectors available from data storage, the feature vectors for any two documents may be quickly retrieved and compared, using an AND operation, to determine which metadata objects, and how many metadata objects of each type, are in common between them. As another example, rather than checking for object matches across each of the objects defined in the object database 116, the server 102 may simply check the object identifiers in the object list 122-1 (e.g., those that are actually present in the source document of interest to a user) to determine which of those identifiers are included in the object list 122-2 (e.g., the target document for which similarity is assessed with respect to the source document).

The processing discussed above to determine a similarity score for document 122-2 with respect to document 120-1 can be repeated for each of the other documents in the document collection. That is, the server 102 can determine a second similarity score for document 122-3 with respect to document 120-1, a third similarity score for document 122-4 with respect to document 120-1, and so on down to a similarity score for document 122-4 with respect to document 120-n.

During stage (D), the server 102 ranks the documents 120-2 to 120-n based on the similarity scores indicating similarity with respect to document 120-1. For example, when higher scores indicate higher similarity, as discussed above, the documents may be ranked from highest similarity score to lowest similarity score.

During stage (E), the server 102 may select a subset of the documents based on the ranking of the documents. For example, the server 102 can select a predetermined number of documents to indicate to the client device 106, such as the 10 top-ranked documents. As additional examples, the server 102 may identify the top 1, 3, 5, or 50 highest-ranked documents.

In addition or as an alternative, a subset of the documents may be selected in other ways. For example, the server 102 may select the predetermined amount of documents from ranked scores based on user preferences. For example, a user preference may specify that the top 10 documents and the associated similarity scores should be indicated. As another example, a user preference may specify that only the top document and the associated similarity score should be indicated. As another example, a user preference may specify that only documents and associated similarity scores that satisfy a predetermined threshold should be indicated.

During stage (F), the server 102 provides data identifying the selected documents to the client device 106 over the network 108. The data identifying a document may include a document identifier, a URL or hyperlink, file name or path, or other reference to a document. The client device 106 can then display icons, hyperlinks, previews, names, or other data representing the selected documents to the user 104. For example, in response to the user 104 selecting a document in his library or personal collection of documents, a portion of the user interface can be populated with icons or other representations of the similar documents identified by the server 102. The user can then select one of the icons to view the indicated document. As another example, the client device 106 can store the data indicating the similar documents, and indicate the documents to the user as recommendations of similar documents after the user 104 reaches the end of the current document being viewed on the client device 106. In some implementations, the server 102 provides the similarity scores for documents to the client device 106, and the indications of the similar documents can be formatted or arranged according to the similarity scores.

The subset of documents identified to be similar to the document 120-1 can be indicated in other ways. For example, the user 104 may perform a swipe right with his/her index finger on a display of the client device 106 when the display shows document 120-1. The client device 106 transitions the current display of document 120-1 to a display showing the selected similar documents similar to document 120-1 and the associated similarity scores. The user 104 may access each of the one or more selected documents on the client device 106 by selecting an indicated document. In other implementations, the client device 106 may display a notification, such as a message, to user 104 when the client device 102 receives the selected documents and the associated similarity scores from the server 102. In other implementations, the server 102 may only provide indications of the similar documents to client device 106.

The operations of stages (A) to (F) illustrate a determining a set of similar documents for a single document 120-1. The server 102 can repeat the operations of stages (A) to (F) to determine a set of documents similar to another document (e.g., other than document 120-1), for example, in response to a user selecting a different document.

In addition, the server 102 may perform the similarity analysis shown in FIG. 1 asynchronously to user interaction with a client device 106. For example, the server system 102 may periodically analyze the documents in document database 114 with respect to each other, and then save data indicating the documents with the highest similarity scores with respect to each document. Then, the set of documents that are most similar to a document can be provided with minimal delay.

The server 102 may store information indicating the contents of a user's library and may access information indicating the documents that a user has recently accessed. The server 102 may determine a set of similar documents for each of these documents that are know to be relevant to a user based on the user's prior actions. The server 102 can then send data indicating the set of similar documents to a client device for storage, so that the set of recommended similar documents can be available when a user requests it. For example, the server 102 can send the client device 106 data indicating a set of similar documents for each document in a user's library. Then, when the user selects a document in the library, the client device 106 already stores the data indicating the set of similar documents that have been identified, and the client device 106 can present the information without needing to obtain it from the server 102.

In other implementations, the server 102 may provide data identifying similar documents in response to a user's request for a particular document. For example, when the client device 106 sends a request for a particular document, the server 102 can send the requested document as well as information indicating documents similar to the requested document. The client device 106 can then display the information indicating the similar documents alongside the requested document, or after the user reaches the end of the requested document.

In some implementations, the document similarity analysis techniques described as being performed by the server 102 can be performed by the client device 106. For example, the client device 106 may locally store document data for a certain set of documents, or may acquire the information over the network 108. The client device 106 may then determine which metadata objects are in common among different documents and generate similarity scores that reflect the amount of shared metadata objects, using the techniques discussed above. The client device 106 may also select a subset of documents to designate as similar to a document, and may display that subset on a user interface.

In some implementations, the similarity scores are generated based on the matches or similarity between the metadata objects used to define documents, without taking into account matches between displayable content of the document. For example, the similarity scores can be determined without considering an amount of matching text that would be shown when the document is viewed. In other implementations, the similarity scores can be combined with other scores that indicate matches between the displayable content of documents. For example, a similarity score can be determined as weighted average of (i) the similarity score based on a degree that metadata objects associated with the documents match, and (ii) a similarity score indicating a degree to which text, images, and/or other displayable content in the documents match.

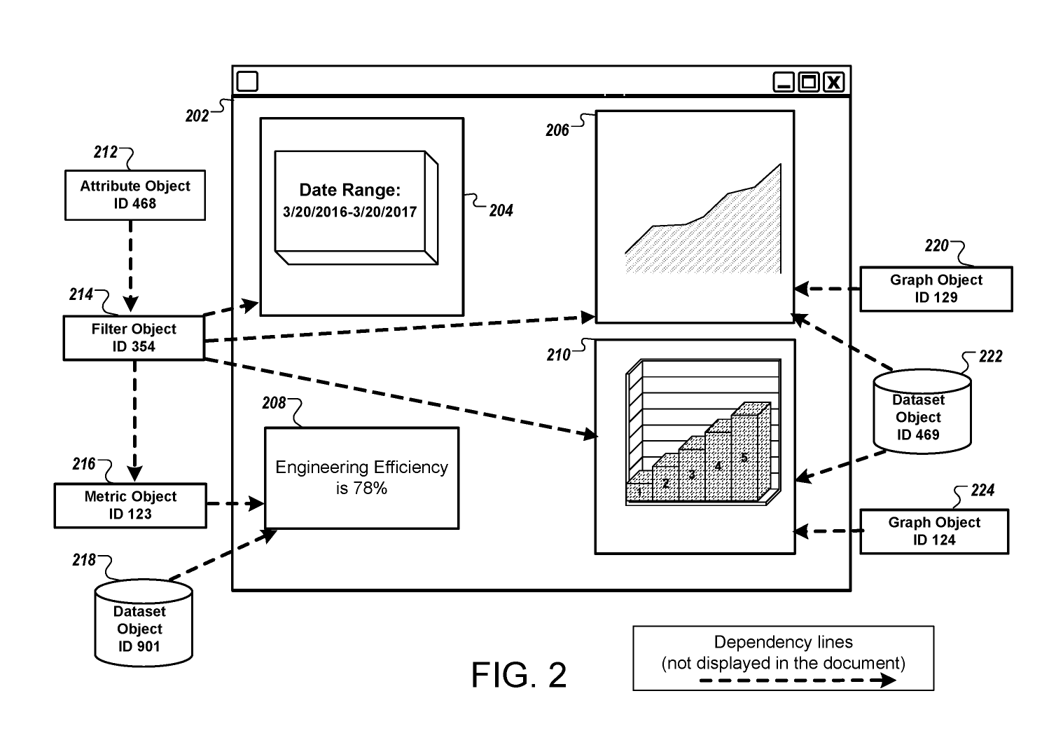

FIG. 2 is a diagram that illustrates an example of document. The diagram shows a user interface 202 showing a view of the document displayed on the client device 106. The diagram shows visual elements 204, 208, 206, 210 that are part of the document view shown to the user. The diagram also shows other elements representing metadata objects 212, 214, 216, 218, 220, 222, 224 that are not part of the document view, but are included to how different types of metadata objects interact to define content of a document.

Each metadata object has a unique object identifier. For example, the metric object 208 includes a metric object identifier “123,” which the server 102 can use for storing and referencing data in the metadata table 118. In some implementations, the server 102 stores the object type associated with the object identifier and the object dependencies associated with the object identifier in the metadata table 118. For example, the server 102 may store the object type “metric” in column 118b associated with the object identifier 123 in the metadata table 118. Additionally, the metric object 208 may depend from the filter object 204, which has an associated filter object identifier 354, as depicted by the dependency line 212 between the metric object 208 and the filter object 204. The filter object 204 may depend from the attributes object 218, which has an associated attribute object identifier 468, as depicted by the dependency line 212 between the filter object 204 and the attributes object 218. Therefore, the metric object identifier 123 may depend from filter object identifier 354 and attributes object identifier 468.

The visual element 208 displays text that indicates a metric generated using a metric object 216. For example, the metric object 216 may define the formula or function used to generate the statistic shown, “78%.” This metric object 216 can be registered in the object database 118 shown in FIG. 1, for example, as a function for calculating an “engineering efficiency” value, which different users could select and use in different documents. Other metadata objects can also define the characteristics of the visual element 208. For example, the dataset object 218 represents a dataset that the metric object 216 operates on to generate the result shown in the document. In addition, the result is affected by a filter object 214 that limits the range of data for the metric object to consider in generating the result. The filter object 214 represents a time-based filter, for example. The filter object 214 in turn is affected by an attribute object 212 that specifies, for example, a specific time range that should be used by the filter represented by filter object 214.

The metadata objects 212, 214, 216, and 218 are used to define the statistic shown in the visual element 208. The dataset object 218 defines the set of source data to be used, the filter object 214 specifies that the data should be filtered to a specific time range, and the attribute object 212 indicates the specific time range that should be used. The metric object 216 then provides the function or algorithm used to operate on the filtered data to produce the statistic of “78%” which is displayed in the document.

In some instances, the document is interactive and dynamically updated. As an example, the data in the data set represented by dataset object 218 could change over time. As another example, a user may be able to define new filter parameters, e.g., by entering or selecting different parameters in the user interface. As a result, when the filter settings are changed, the result of the metric may be recomputed and the new result displayed. The document may reference the various metadata objects in order to facilitate these changes. For example, to generate the document, the information about the different metadata objects may be retrieved and processed to generate the view of the document.

In other implementations, the metadata objects 212, 214, 216, 218 may be used at the time of creation of the document, but may not be directly referenced by or required to display the document, even if the document is interactive. For example, the metric object 216 could be selected by a user when creating the document, but the document could simply include the result of the calculation, or embed an equation to generate the result. In these instances, the document may include metadata that specifies the metric object 216 used, or the server 102 may store the information indicating that the metric object 216 was used in a separate metadata file or database.

The other visual elements of the document, such as a filter control 204, a line graph 206, and a bar graph 210, are similarly defined by various metadata objects. The filter object 214 defines parameters of the filter control 204 that is shown to the user, e.g., the type of filtering (e.g., by time, by location, by company, etc.) and what parameters are shown. The filter object 204 may filter input data by passing the input data through a particular function. For example, filter object 204 may receive data from the attributes object data 218 and filter the data by a date range function, such as between the dates Mar. 20, 2016 to Feb. 30, 2017. The filter object 204 may use other functions such as matching similar data types, matching similar data sizes, comparing data to satisfy a threshold, to name a few examples.

The filter object 214 can affect multiple other visual elements, including the line graph 206 and the bar graph 210. These visual elements 206, 210 each have corresponding metadata objects 220, 224 that define their characteristics, and both visual elements 206, 210 illustrate data from a dataset object 222. In some implementations, the line graph object 206 and the bar chart object 210 may visually display data associated with one or more inputs, e.g., the data from the dataset object 222, as filtered according to the filter object 214.

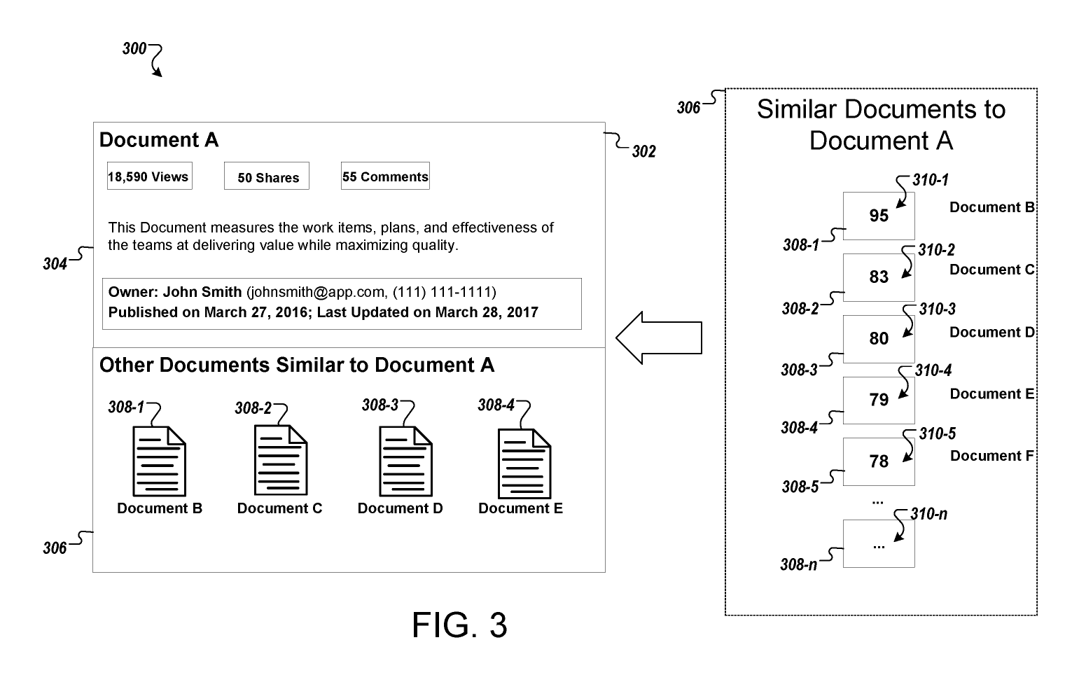

FIG. 3 is a diagram that illustrates an example of a user interface 300 showing results of document similarity analysis. In some implements, the user interface 300 can include results of the document similarity analysis in response to stage (F) of FIG. 1.

In the example of FIG. 3, the user interface 300 illustrates the display of client device 106 in response to user 104 interacting with the client device 104 to select document A. The user interface 300 displays a description of document A in a first display region 304. Document A is the reference document that other documents were compared against during the similarity analysis. That is, the similar documents represented in FIG. 3 were each assessed to determine how similar they were to Document A.

The diagram shows a set of scores 306 representing the results of similarity analysis. The server 102 may provide these scores or the ranking of the documents to the client device 106. The documents assessed by the server 102 are represented as documents 308-1 to 308-n. Each of these documents has a corresponding similarity score 310-1 to 310-n. In the example, document 308-1, labeled “Document B,” has the highest similarity score 310-1 with a value of “95,” indicating that it has the highest weighted similarity to document A, where the weighted similarity score which can factor in likelihood of a document being viewed rather than using strict similarity alone. Document 308-2, which is labeled “Document C” and has a similarity score 310-2 of “83,” is next in the ranking, and so on.

In some implementations, the client device 106 can allow the user to select the similar documents in the similar documents display 306. For example, user 104 may select document B 308-1 to view by tapping on the display of client device 106 at a location indicated by document B. In response, the client device 106 may send a request to the server 102 to retrieve document B 308-1. In some implementations, the client device 106 requesting for a particular document, such as document B 308-1, triggers the document similarity analysis for the requested document. For example, the server 102 may receive a request to open document B 308-1 and in response determine similar documents to document B 308-1. The server 102 transmits document B 308-1 and the document similarities 308 with the associated similarity scores to the client device 106.

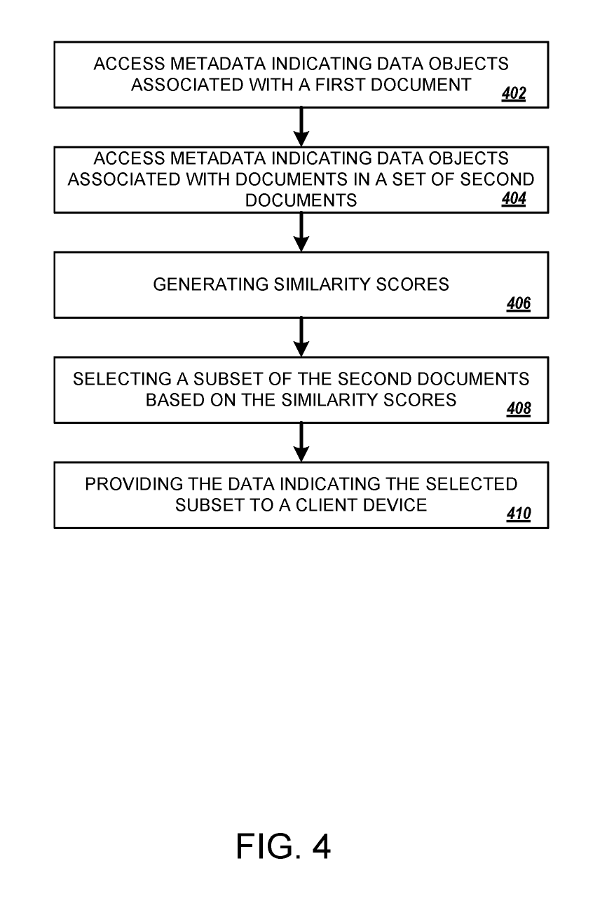

FIG. 4 is a flow diagram of an example process 400 for document similarity analysis. The process can be performed by one or more computers. The process 400 is described below as being performed by the server 102 of FIG. 1, but can be performed by any appropriate computing device or combination of computing devices.

The server 102 accesses first metadata identifying a first set of metadata objects that define characteristics of the first document (402). The metadata objects can be associated with the document in various ways. For example, object identifiers or other references to the metadata objects can be included in the first document as metadata. As another example, an index or repository of metadata can include data indicating which metadata objects specify the content to be displayed in the document.

The metadata objects that define characteristics of the first document can be included in or referenced by the first document. In this manner, the metadata objects can be components of the first document or objects that specify displayable content of the first document. In some instances, the metadata objects are metadata that define elements that many different users can select to define content of different documents. The metadata that is accessed may indicate metadata objects that were used to define a document at the time the document was created or edited, even if the resulting document does not directly reference those metadata objects.

The server 102 accesses second metadata identifying metadata objects that define characteristics of documents in a set of second documents (404). The metadata may be determined in the same manner that metadata was determined for the first document. For example, the metadata may be extracted from the second documents, accessed from an index or metadata repository.

The server 102 generates similarity scores indicating similarity of the second documents with respect to the first document (406). The similarity score for each second document can be generated based on an amount of elements in common between (i) the first set of metadata objects and (ii) the set of metadata objects that define characteristics of the second document.

In some implementations, the server determines a first set of identifiers of metadata objects associated with the first document, and a second set of identifiers for metadata objects associated with a particular second document. The similarity score for the particular second document can be determined by identifying matching identifiers in first set of identifiers and the second set of identifiers.

The similarity score for a particular document with respect to the first document can also be determined by determining a similarity measure for each of multiple different categories of metadata objects, determining a weighting for each of the multiple different categories, and weighting the similarity measures for the multiple different categories by their respective weightings. In this manner, matches of different object types can be given different levels of influence in determining the similarity score.

The determination of a similarity score can also take into account dependencies of one metadata object on another. For example, the server can determine first metadata objects are referenced by the first document, and determine that the first metadata objects depend on additional metadata objects that are not referenced by the first document. A combined set of metadata objects, that includes the first metadata objects and the additional metadata objects, can be used to identify metadata objects in common with other documents. In a similar manner, the metadata objects associated with a second document through dependency can also be identified and used in the comparison.

In some implementations, similarities among the types of objects included in a document can be used to indicate document similarity, even if the specific objects do not match. The similarity score for a particular document can be based on determining that the first document and the particular document each reference metadata objects of a same object type. For example, if the first document and a second document each include a chart metadata object, but not the same chart metadata object, a matching element can be identified and used to indicate similarity. This match may be weighted less than other matches indicating that the same metadata object is used.

The similarity score can be determined using document access history data. For example, a measure of similarity can be weighted using a value indicating a likelihood of access of a document. A weighting value can be determined based on an amount of accesses of a particular document relative to accesses of other documents in a data collection. Thus, each document compared to the first document may be weighted according to its own access frequency, so that documents that are infrequently accessed have lower similarity scores.

The server 102 selects a subset of the second documents based on the similarity scores (408). For example, the second documents can be ranked according to their similarity scores, and a predetermined number of the highest-ranked documents can be selected. For example, the top 1, 5, or 10 highest-ranked documents can be selected.

The server 102 provides data indicating the selected subset of the second documents to a client device (410). For example, the server can provide the subset of the second documents as recommend documents or as a set of documents similar to the first document. This information may be provided in response to a request for documents similar to a first document, in response to a query from the client device, in response to a request from the client device to view or download the first document, or in response to other actions. For example, the server 102 may provide the information about similar documents in response to receiving data from the client device indicating that the user selected the first document on a user interface of the client device. As another example, the server 102 may provide the data indicating the selected subset in response to determining that the first document is in a document collection associated with the user, such as a user's document library.

In some implementations, the server 102 identifies a the document for which similar documents should be identified based on one or more of various factors. The various factors may be, for example: receiving data indicating user input to select the first document; receiving data indicating that a user accessed the first document; receiving data indication an end of the first document is reached; or determining that the first document is in a document collection of the first user. The server 102 may initiate similarity analysis in response to one of these events, or may provide an indication of documents previously identified as similar, e.g., from records stored prior to the event.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

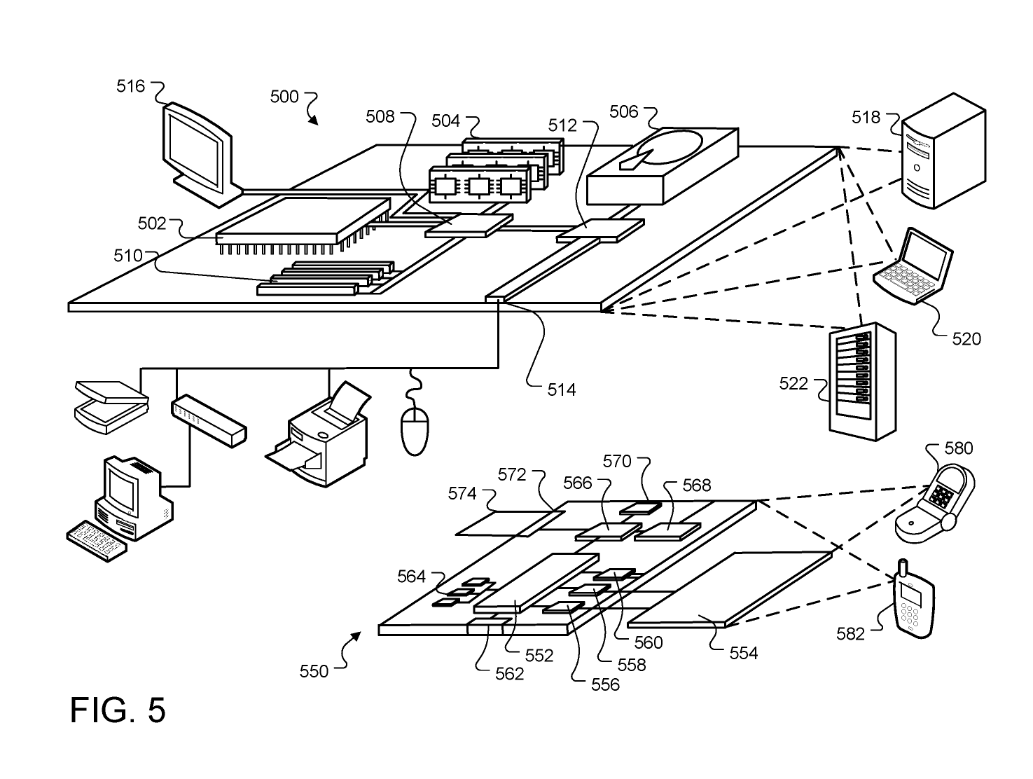

FIG. 5 shows an example of a computing device 500 and a mobile computing device 550 that can be used to implement the techniques described here. The computing device 500 is intended to represent various forms of digital computers, such as laptops, desktops, workstations, personal digital assistants, servers, blade servers, mainframes, and other appropriate computers. The mobile computing device 550 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 500 includes a processor 502, a memory 504, a storage device 506, a high-speed interface 508 connecting to the memory 504 and multiple high-speed expansion ports 510, and a low-speed interface 512 connecting to a low-speed expansion port 514 and the storage device 506. Each of the processor 502, the memory 504, the storage device 506, the high-speed interface 508, the high-speed expansion ports 510, and the low-speed interface 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as a display 516 coupled to the high-speed interface 508. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 504 stores information within the computing device 500. In some implementations, the memory 504 is a volatile memory unit or units. In some implementations, the memory 504 is a non-volatile memory unit or units. The memory 504 may also be another form of computer-readable medium, such as a magnetic or optical disk.

The storage device 506 is capable of providing mass storage for the computing device 500. In some implementations, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 502), perform one or more methods, such as those described above. The instructions can also be stored by one or more storage devices such as computer- or machine-readable mediums (for example, the memory 504, the storage device 506, or memory on the processor 502).

The high-speed interface 508 manages bandwidth-intensive operations for the computing device 500, while the low-speed interface 512 manages lower bandwidth-intensive operations. Such allocation of functions is an example only. In some implementations, the high-speed interface 508 is coupled to the memory 504, the display 516 (e.g., through a graphics processor or accelerator), and to the high-speed expansion ports 510, which may accept various expansion cards (not shown). In the implementation, the low-speed interface 512 is coupled to the storage device 506 and the low-speed expansion port 514. The low-speed expansion port 514, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 518, or multiple times in a group of such servers. In addition, it may be implemented in a personal computer such as a laptop computer 520. It may also be implemented as part of a rack server system 522. Alternatively, components from the computing device 500 may be combined with other components in a mobile device (not shown), such as a mobile computing device 550. Each of such devices may contain one or more of the computing device 500 and the mobile computing device 550, and an entire system may be made up of multiple computing devices communicating with each other.

The mobile computing device 550 includes a processor 552, a memory 564, an input/output device such as a display 554, a communication interface 566, and a transceiver 568, among other components. The mobile computing device 550 may also be provided with a storage device, such as a micro-drive or other device, to provide additional storage. Each of the processor 552, the memory 564, the display 554, the communication interface 566, and the transceiver 568, are interconnected using various buses, and several of the components may be mounted on a common motherboard or in other manners as appropriate.

The processor 552 can execute instructions within the mobile computing device 550, including instructions stored in the memory 564. The processor 552 may be implemented as a chipset of chips that include separate and multiple analog and digital processors. The processor 552 may provide, for example, for coordination of the other components of the mobile computing device 550, such as control of user interfaces, applications run by the mobile computing device 550, and wireless communication by the mobile computing device 550.

The processor 552 may communicate with a user through a control interface 558 and a display interface 556 coupled to the display 554. The display 554 may be, for example, a TFT (Thin-Film-Transistor Liquid Crystal Display) display or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may provide communication with the processor 552, so as to enable near area communication of the mobile computing device 550 with other devices. The external interface 562 may provide, for example, for wired communication in some implementations, or for wireless communication in other implementations, and multiple interfaces may also be used.

The memory 564 stores information within the mobile computing device 550. The memory 564 can be implemented as one or more of a computer-readable medium or media, a volatile memory unit or units, or a non-volatile memory unit or units. An expansion memory 574 may also be provided and connected to the mobile computing device 550 through an expansion interface 572, which may include, for example, a SIMM (Single In Line Memory Module) card interface. The expansion memory 574 may provide extra storage space for the mobile computing device 550, or may also store applications or other information for the mobile computing device 550. Specifically, the expansion memory 574 may include instructions to carry out or supplement the processes described above, and may include secure information also. Thus, for example, the expansion memory 574 may be provided as a security module for the mobile computing device 550, and may be programmed with instructions that permit secure use of the mobile computing device 550. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier, such that the instructions, when executed by one or more processing devices (for example, processor 552), perform one or more methods, such as those described above. The instructions can also be stored by one or more storage devices, such as one or more computer- or machine-readable mediums (for example, the memory 564, the expansion memory 574, or memory on the processor 552). In some implementations, the instructions can be received in a propagated signal, for example, over the transceiver 568 or the external interface 562.

The mobile computing device 550 may communicate wirelessly through the communication interface 566, which may include digital signal processing circuitry where necessary. The communication interface 566 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 568 using a radio-frequency. In addition, short-range communication may occur, such as using a Bluetooth, Wi-Fi, or other such transceiver (not shown). In addition, a GPS (Global Positioning System) receiver module 570 may provide additional navigation- and location-related wireless data to the mobile computing device 550, which may be used as appropriate by applications running on the mobile computing device 550.

The mobile computing device 550 may also communicate audibly using an audio codec 560, which may receive spoken information from a user and convert it to usable digital information. The audio codec 560 may likewise generate audible sound for a user, such as through a speaker, e.g., in a handset of the mobile computing device 550. Such sound may include sound from voice telephone calls, may include recorded sound (e.g., voice messages, music files, etc.) and may also include sound generated by applications operating on the mobile computing device 550.

The mobile computing device 550 may be implemented in a number of different forms, as shown in the figure. For example, it may be implemented as a cellular telephone 580. It may also be implemented as part of a smart-phone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. For example, while a client application is described as accessing the delegate(s), in other implementations the delegate(s) may be employed by other applications implemented by one or more processors, such as an application executing on one or more servers. In addition, the logic flows depicted in the figures do not require the particular order shown, or sequential order, to achieve desirable results. In addition, other actions may be provided, or actions may be eliminated, from the described flows, and other components may be added to, or removed from, the described systems. Accordingly, other implementations are within the scope of the following claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method performed by one or more computers, the method comprising:
accessing, by the one or more computers, first metadata identifying a first set of metadata objects that define characteristics of a first document;
accessing, by the one or more computers, second metadata identifying metadata objects that define characteristics of documents in a set of second documents;
generating, by the one or more computers, similarity scores indicating similarity of the second documents with respect to the first document, wherein the similarity score for a second document is generated based on an amount of elements in common between (i) the first set of metadata objects and (ii) the set of metadata objects that define characteristics of the second document;
selecting, by the one or more computers, a subset of the second documents based on the similarity scores; and
providing, by the one or more computers, data indicating the selected subset of the second documents to a client device.

2. The method of claim 1, wherein accessing the first metadata comprises determining a first set of identifiers of metadata objects that are referenced by or were used to generate the first document;
wherein accessing the second metadata comprises determining, for a particular document in the set of second documents, a second set of identifiers of metadata objects that are referenced by or were used to generate content of the particular document; and
wherein generating the similarity scores comprises determining a similarity score for the particular document based on identifying matching identifiers in first set of identifiers and the second set of identifiers.

3. The method of claim 1, wherein generating the similarity scores comprises determining a similarity score for a particular document of the second documents by:
determining a similarity measure for each of multiple different categories of metadata objects;
determining a weighting for each of the multiple different categories; and
determining the similarity score based on weighting the similarity measures for the multiple different categories by their respective weightings.

4. The method of claim 1, wherein accessing the metadata indicating the elements of the first document comprises:
determining first metadata objects are referenced by the first document;
determining that the first metadata objects depend on additional metadata objects that are not referenced by the first document; and
determining, as the first set of metadata objects, a combined set of metadata objects that includes the first metadata objects and the additional metadata objects.

5. The method of claim 1, wherein generating the similarity scores comprises determining a similarity score for a particular document of the second documents based on determining that the first document and the particular document each reference metadata objects of a same object type.

6. The method of claim 1, further comprising identifying the first document, comprising at least one of:
receiving data indicating user input to select the first document;
receiving data indicating that a user accessed the first document;
receiving data indication an end of the first document is reached; or
determining that the first document is in a document collection of the first user.

7. The method of claim 1, wherein generating the similarity scores comprises determining a similarity score for a particular document of the second documents based on data indicating a frequency of access of the second document.

8. The method of claim 1, wherein providing the data indicating the selected subset of the second documents to a client device is performed in response to receiving data indicating that a user of the client device selected the first document.

9. A system comprising:
one or more computers; and
one or more computer-readable media comprising instructions that, when executed by the one or more computer-readable media, cause the one or more computers to perform operations comprising:
accessing, by the one or more computers, first metadata identifying a first set of metadata objects that define characteristics of a first document;
accessing, by the one or more computers, second metadata identifying metadata objects that define characteristics of documents in a set of second documents;
generating, by the one or more computers, similarity scores indicating similarity of the second documents with respect to the first document, wherein the similarity score for a second document is generated based on an amount of elements in common between (i) the first set of metadata objects and (ii) the set of metadata objects that define characteristics of the second document;
selecting, by the one or more computers, a subset of the second documents based on the similarity scores; and
providing, by the one or more computers, data indicating the selected subset of the second documents to a client device.

10. The system of claim 9, wherein accessing the first metadata comprises determining a first set of identifiers of metadata objects that are referenced by or were used to generate the first document;
wherein accessing the second metadata comprises determining, for a particular document in the set of second documents, a second set of identifiers of metadata objects that are referenced by or were used to generate content of the particular document; and
wherein generating the similarity scores comprises determining a similarity score for the particular document based on identifying matching identifiers in first set of identifiers and the second set of identifiers.

11. The system of claim 9, wherein generating the similarity scores comprises determining a similarity score for a particular document of the second documents by:
determining a similarity measure for each of multiple different categories of metadata objects;
determining a weighting for each of the multiple different categories; and
determining the similarity score based on weighting the similarity measures for the multiple different categories by their respective weightings.

12. The system of claim 9, wherein accessing the metadata indicating the elements of the first document comprises:
determining first metadata objects are referenced by the first document;
determining that the first metadata objects depend on additional metadata objects that are not referenced by the first document; and
determining, as the first set of metadata objects, a combined set of metadata objects that includes the first metadata objects and the additional metadata objects.

13. The system of claim 9, wherein generating the similarity scores comprises determining a similarity score for a particular document of the second documents based on determining that the first document and the particular document each reference metadata objects of a same object type.

14. The system of claim 9, wherein the operations further comprise identifying the first document, comprising at least one of:
receiving data indicating user input to select the first document;
receiving data indicating that a user accessed the first document;
receiving data indication an end of the first document is reached; or
determining that the first document is in a document collection of the first user.

15. The system of claim 9, wherein generating the similarity scores comprises determining a similarity score for a particular document of the second documents based on data indicating a frequency of access of the second document.

16. The system of claim 9, wherein providing the data indicating the selected subset of the second documents to a client device is performed in response to receiving data indicating that a user of the client device selected the first document.

17. One or more non-transitory computer-readable media comprising instructions that, when executed by the one or more computer-readable media, cause the one or more computers to perform operations comprising:
accessing, by the one or more computers, first metadata identifying a first set of metadata objects that define characteristics of a first document;
accessing, by the one or more computers, second metadata identifying metadata objects that define characteristics of documents in a set of second documents;
generating, by the one or more computers, similarity scores indicating similarity of the second documents with respect to the first document, wherein the similarity score for a second document is generated based on an amount of elements in common between (i) the first set of metadata objects and (ii) the set of metadata objects that define characteristics of the second document;
selecting, by the one or more computers, a subset of the second documents based on the similarity scores; and
providing, by the one or more computers, data indicating the selected subset of the second documents to a client device.

18. The one or more non-transitory computer-readable media of claim 17, wherein accessing the first metadata comprises determining a first set of identifiers of metadata objects that are referenced by or were used to generate the first document;
wherein accessing the second metadata comprises determining, for a particular document in the set of second documents, a second set of identifiers of metadata objects that are referenced by or were used to generate content of the particular document; and
wherein generating the similarity scores comprises determining a similarity score for the particular document based on identifying matching identifiers in first set of identifiers and the second set of identifiers.

19. The one or more non-transitory computer-readable media of claim 17, wherein generating the similarity scores comprises determining a similarity score for a particular document of the second documents by:
determining a similarity measure for each of multiple different categories of metadata objects;
determining a weighting for each of the multiple different categories; and
determining the similarity score based on weighting the similarity measures for the multiple different categories by their respective weightings.

20. The one or more non-transitory computer-readable media of claim 17, wherein accessing the metadata indicating the elements of the first document comprises:
determining first metadata objects are referenced by the first document;
determining that the first metadata objects depend on additional metadata objects that are not referenced by the first document; and
determining, as the first set of metadata objects, a combined set of metadata objects that includes the first metadata objects and the additional metadata objects.
